(19) United States
(12) Patent Application Publication
(10) Pub. No.: US 2007/0076645 A1
(43) Pub. Date: Apr. 5, 2007

(54) Signal repeater system

(76) Inventor: Paul J. VanDrunen, Navarre, FL (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/241,564

(22) Filed: Sep. 30, 2005

(51) Int. Cl. H04J 1/10; H04B 7/14; H04J 3/08

(52) U.S. Cl. 370/315

(57) ABSTRACT

A signal repeater system in a repeater unit having a repeater receiver, a repeater transmitter, a controller, a power source, and an optional network interface. The repeater unit performs an authentication of security codes contained in the received communication signals. If validly authenticated, the repeater unit retransmits the communication signals to a barrier operator. The transmitted communication signals may also contain predetermined functions that allow a remote transmitter to actuate an access barrier, such as a garage door opener, via the barrier operator. As such, the repeater system extends the effective range of the remote transmitter, allowing a user to actuate the barrier operator from a greater range. An optional network interface provided by the repeater unit, allows the repeater unit to be connected to any computer network. Accordingly, a remote host can access certain data content and invoke certain functions.

### TECHNICAL BACKGROUND

The present invention relates to signal repeaters. Specifically, the present invention relates to a signal repeater that only retransmits received signals that have been authenticated by the signal repeater. Particularly, the present invention relates to a signal repeater having a network interface, allowing a remote host to access certain functions and/or data provided by the signal repeater over a computer network.

### BACKGROUND

A signal repeater, or repeater is typically used in conjunction with a transmitter/receiver pair to extend the reception range of the receiver. Specifically, the repeater receives a transmitted signal, and then retransmits the signal to the intended receiver. The repeater often increases the power of the received signal or performs other processes on the received signal to increase the receiver's effective reception range.

In the context of barrier operators, such as garage door openers, a remote transmitter and receiver are used to allow a user to remotely move an access barrier between open and closed positions. However, barrier operators are often exposed to various interference sources such as noise from adjacent power wires, electric motor noise from the operation of the barrier operator, and from spurious transmission signals, such as radio and television signals, transmitted in the vicinity of the barrier operator. Furthermore, when a garage door is used in association with a barrier operator, and the garage door is in its closed position, the door itself acts as a barrier to signals attempting to reach the barrier operator's receiver. As a result, the reception range of the receiving unit provided by the barrier operator is reduced. This impedes the user of the barrier operator from remotely actuating the access barrier from a long range. The accuracy of the receiving unit may also be diminished as the barrier operator must identify the signal sent by a remote user from the other interfering signals that may be present. Thus, a user may need to send multiple signals from the remote transmitter before a recognizable signal is actually received by the barrier operator.

To overcome the reception problems associated with barrier operators, an external antenna kit is often used. However, because of the nature and location of the mounted barrier operator, the installer of such kit must identify a suitable route for running a coaxial antenna wire and/or external power supply wires between the external antenna and the barrier operator. As such, the process of installing an antenna kit is often cumbersome and costly.

Therefore, there is a need for a signal repeater for use with the remote transmitter and the receiver of a barrier operator to extend the reception range of the barrier operator. Additionally, there is a need for a repeater that provides filtering to a received signal to reduce interference. Furthermore, there is a need for a repeater that provides connectivity to a computer network which allows a user to interact with data and functions that may be provided by the repeater.

### DISCLOSURE OF THE INVENTION

In light of the foregoing, it is a first aspect of the present invention to provide a signal repeater system.

It is another aspect of the present invention to provide a repeater unit to retransmit communication signals received from a remote transmitter comprising: a repeater receiver having a receiver antenna to receive the communication signal, a controller adapted to store and authenticate the received communication signal, a repeater transmitter having a transmitter antenna, the repeater transmitter coupled to the controller, wherein the repeater transmitter retransmits the stored communication signal if the communication signal is authenticated by the controller.

Yet another aspect of the present invention is a method of retransmitting a received communication signal from a remote transmitter comprising: providing a barrier operator having a communication signal reception range, providing a repeater unit having a communication signal transmission range, positioning the repeater unit relative to the barrier operator, such that the communication signal transmission range of the repeater unit overlaps the communicational signal reception range of the barrier operator, transmitting a communication signal from a remote transmitter to actuate the barrier operator, receiving the transmitted communication signal at the repeater unit, storing the transmitted communication signal at the repeater unit, authenticating the communication signal at said repeater unit to determine if the communication signal originates from the learned remote transmitter, and retransmitting the communication signal to the barrier operator by the repeater unit of the repeater unit validates the communication signal at the authenticating step.

### BRIEF DESCRIPTION OF THE DRAWINGS

These and other features and advantages of the present invention will become better understood with regard to the following description, appended claims, and accompanying drawings wherein:

FIG. 1 is a block diagram of a signal repeater system in accordance with the concepts of the present invention; and

FIG. 2 is a state diagram of the operating steps performed by the signal repeater system shown in FIG. 1.

### BEST MODE FOR CARRYING OUT THE INVENTION

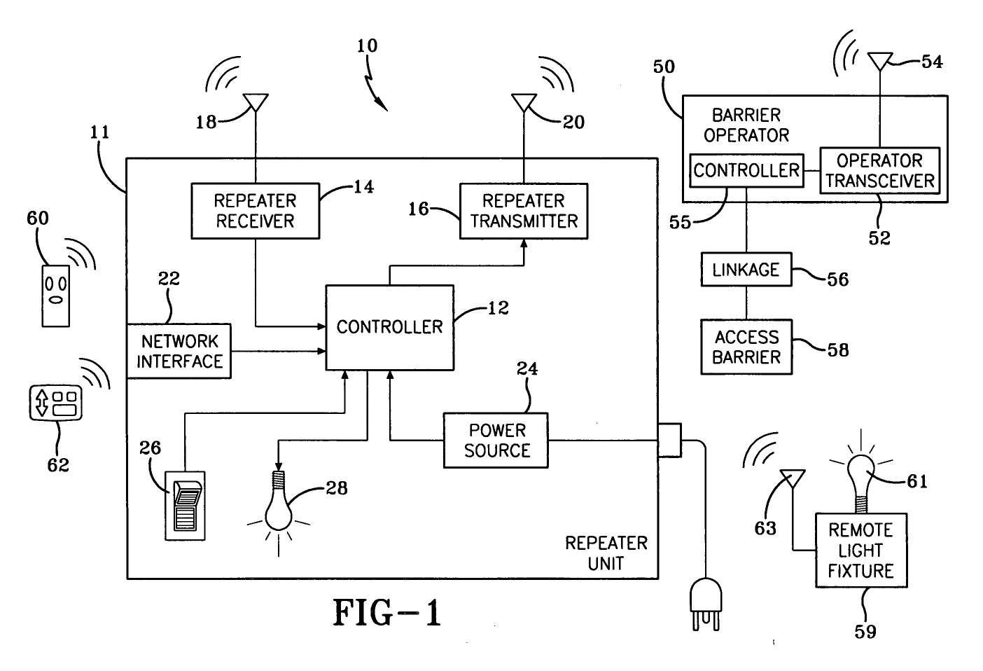

A signal repeater system is generally designated by the numeral 10, as shown in FIG. 1 of the drawings. Although the following discussion relates to the use of the signal repeater system in association with barrier operators and remote transmitters, the signal repeater system 10 may be readily adapted for use with any other system that utilizes a wireless transmitter/receiver pair.

The signal repeater system 10 of the present invention includes a repeater unit 11 having a controller 12. The controller 12 comprises a logic control that may be implemented using a general purpose, or application specific semiconductor based microprocessor/microcontroller that provides the necessary hardware, software, and memory to carry out the desired functions to be described. The memory provided by the controller 12 may comprise non-volatile memory (NVM), volatile memory, or both. Such NVM may comprise an eraseable programmable memory (EPROM), an electrically eraseable programmable memory (EEPROM), a one time programmable memory (OTP), or other suitable non-volatile memory device. The volatile memory may comprise a dynamic random access memory (DRAM), static random access memory (SRAM), or other suitable volatile memory. Coupled to the controller 12 is a repeater receiver 14 that is able to receive wireless communication signals transmitted from a distance. The distance from which a communication signal may be received may be established using known techniques to modify the repeater receiver 14. While the repeater receiver 14 typically is used to receive radio frequency (RF) signals, the receiver can be readily adapted to use any other communication frequency and protocol, such as infrared, microwave, sonic, or other suitable communication frequency.

A repeater transmitter 16 is coupled to the controller 12 for the purpose of transmitting wireless signals. The signals transmitted by the repeater transmitter 16 typically comprise radio frequency (RF) signals, but may be adapted to transmit other communication frequencies and/or protocols as previously discussed with respect to the repeater receiver 14. Coupled to the respective repeater receiver 14 and repeater transmitter 16 are a receiver antenna 18 and a transmitter antenna 20.

A network interface 22 is also coupled to the controller 12. The network interface 22 may comprise an Ethernet interface, USB (universal serial bus) interface, IEEE 1394 interface, or other suitable interface for connection to a WAN (wide area network), such as the Internet, LAN (local area network), or any other computer network. For example, an Ethernet network adapter having an RJ-45 type-connection may comprise the network interface 22. In one embodiment, the network interface 22 may comprise a wireless interface allowing the repeater unit 11 to be connected to a computer network wirelessly. Such wireless protocols including Bluetooth™, WiFi™, WiMax™, or other known or future wireless networking protocol may be used to implement the wireless interface. A power source 24 is also coupled to the controller 12. The power source 24 may comprise a dry cell battery, an AC/DC power supply for connection to mains power as shown in FIG. 1, or any other suitable power source. Mains power is defined herein as standard commercial line power, such as 120VAC. In addition, the repeater unit 11 includes a selector 26 that is coupled to the controller 12. The selector 26 may comprise a button, switch, or the like, and allows the user of the repeater system 12 to invoke certain modes provided by the controller 12, including a learning mode, which will be discussed later. Also coupled to the controller is an indicator 28 that may comprise any suitable light emitting device, including but not limited to an LED (light emitting diode), incandescent lamp, LCD (liquid crystal display) or other suitable light emitting device. Furthermore, the indicator 28 may illuminate in various patterns and/or colors to denote certain states that the repeater unit 11 may be in. For example, the states denoted by the indicator 28 may include low power, power failure, learning mode invoked, or any other state that the repeater unit 11 may take on.

A barrier operator 50 used in association with the repeater system 10 may include an operator transceiver 52 and operator antenna 54 that allows the barrier operator 50 to receive and transmit communication signals. However, in lieu of a transceiver 52, separate receiver and transmitter units may be used to provide the signal transmitting and receiving functions provided by transceiver 52. The operator transceiver 52 may have a signal reception range that is of a desired distance, and that is suitable to receive remotely transmitted communication signals. It should be appreciated that such communication signals may comprise any desired frequency, or communication protocol, as previously discussed with respect to the repeater unit 11. To provide control of the barrier operator 50, a controller 55 is provided. The controller 55 comprises a logic control that may be implemented using a general purpose, or application specific semiconductor based microprocessor/microcontroller that provides the necessary hardware, software, and memory to carry out the desired functions described. Thus, briefly, when communication signals are received by the operator antenna 54 and operator transceiver 52, the controller 55 generates the appropriate control signals needed to move an access barrier 58 (discussed below) between open and closed positions. For example, an electric motor (not shown) may be coupled to the access barrier 58, whereby the access barrier 58 is moved between open and closed positions in response to a control signal sent from the controller 55.

The barrier operator 50 is coupled via linkage 56 to the access barrier 58, thereby allowing the barrier operator 50 to move the access barrier between open and closed positions. The linkage 56 may be a counter-balancing system used to assist in moving the barrier between open and closed positions. Furthermore, the linkage 56 may also be part of a header-mounted, trolley type, screw drive, jackshaft or any other mechanism used to assist in moving the access barrier 58. It should be appreciated that the access barrier 58 may comprise a garage door, gate, or other device to modulate ingress and egress through the access barrier's path.

It should also be appreciated that the barrier operator 50 may also include a remote light fixture 59 configured to be in wireless communication with the barrier operator 50. Specifically, the remote light fixture 59 may comprise a light source 61 and a light fixture antenna 63 to wirelessly communicate with the barrier operator 50. The light source 61 may comprise an incandescent, fluorescent, or any other suitable light source. Briefly, to initiate the operator of the remote light fixture 59, the barrier operator 50 may send suitable communication signals to the remote light fixture 59 to turn the light source 61 on or off.

The repeater system 10 also includes a remote transmitter 60, which allows a user to remotely initiate certain functions of the barrier operator 50 by sending communication signals embodying those functions from the remote transmitter 60. For example, the remote transmitter 60 may have an open/close function, whereby upon the selection of such function at the remote transmitter 60 results in the access barrier 54 being actuated between open and closed positions. A wireless wall station 62 may also be used to remotely actuate the barrier operator 50, in order to move the access barrier 58 between open and closed positions. It should also be appreciated that the remote transmitter 60 and the wall station 62 may also provide a learn mode that will be discussed later. Hereinafter, any reference in the following discussion to the remote transmitter 60 will also include the wall station 62, unless stated otherwise. Of course, a wall station transmitter may also be directly wired to the operator 50 to initiate various functions. It is also contemplated that the user may remotely actuate the remote light fixture 59 by selecting the appropriate function at the remote transmitter 60 or wall station 62. Once the barrier operator 50 receives the communication signal embodying the function, the barrier operator 50 then transmits a suitable communication signal to the remote light fixture 59. For example, a user may remotely turn the light source 61 of the remote light fixture on and off remotely using either the remote transmitter 60 or the wall station 62. And toggling of the light fixture may be initiated as a result of barrier movement.

To prevent unauthorized remote transmitters 60 from actuating the barrier operator 50, an authentication process is employed that uses various security codes contained in a transmitted communication signal, that uniquely identify each individual transmitter unit 60. Such security codes may comprise rolling or hopping codes, such as that provided in devices made by Microchip Technology, Inc. under the trademark KEELOQ®. When a specific remote transmitter 60 is sought to actuate the barrier operator 50, a learn mode provided by both the remote transmitter 60 and the barrier operator 50 is entered. Once the learn mode is entered, the security code of the remote transmitter 60 is stored by the barrier operator 50. Thus, when a communication signal is received by the barrier operator 50, the signal is authenticated to determine if the security code has been previously learned with the barrier operator 50. As a result of the authentication process, only remote transmitters 60 that have been previously learned with the barrier operator 50 are capable of actuating the various functions provided by the barrier operator 50, such as the open/close function. Moreover, any remote transmitters 60 that have not been learned with the barrier operator 50 are prevented from actuating the functions provided thereby.

In addition to authenticating a remote transmitter's security code by the barrier operator 50, the security code may also be authenticated by the repeater unit 11. To achieve this, the remote transmitter 60 is learned with repeater unit 11 in a manner similar to the barrier operator 50, whereby the security code is stored in the memory of the controller 12 of the repeater unit 11. In one embodiment, the learn mode provided by the repeater unit 11 may be initiated by actuating the selector 26. It is also contemplated that in one embodiment of the signal repeater system 10, communication signals received by the repeater unit 11 may not be authenticated prior to their subsequent retransmission. It should also be appreciated that in one embodiment that the repeater unit 11 may download security codes that have been learned to the barrier operator 50. As such the time required to learn individual remote transmitters 60 with the repeater unit 11 is obviated.

To put the repeater unit 11 into use, and after the particular remote transmitter 60 has been learned with both the barrier operator 50 and the repeater unit 11, the repeater unit 11 is positioned such that the transmission range of the repeater unit 11 and the reception range of the barrier operator 50 overlap each other. The overlapping of the ranges allows the repeater unit 11 to transmit communication signals that can be received by the barrier operator 50. As such, the repeater system 10 allows the remote transmitter 60 to send transmission signals to the barrier operator 50 when the remote transmitter 60 is outside of the reception range of the barrier operator 50, thereby extending the effective range from which a remote transmitter 60 can actuate the barrier operator 50.

Once the repeater receiver 14 of the repeater unit 11 receives a communication signal from the remote transmitter 60, the controller 12 performs an authentication of the communication signal to determine if the security code of the remote transmitter 60 matches the security codes stored in the memory of the controller 12. If the security code fails the authentication process, indicating the security code of the remote transmitter 60 has not been learned with the repeater unit 11, then the communication signal is not retransmitted by the repeater unit 11. However, if the security code is validated by the authentication process, then the communication signal received by the repeater unit 11 from the remote transmitter 60 is retransmitted to the barrier operator 50.

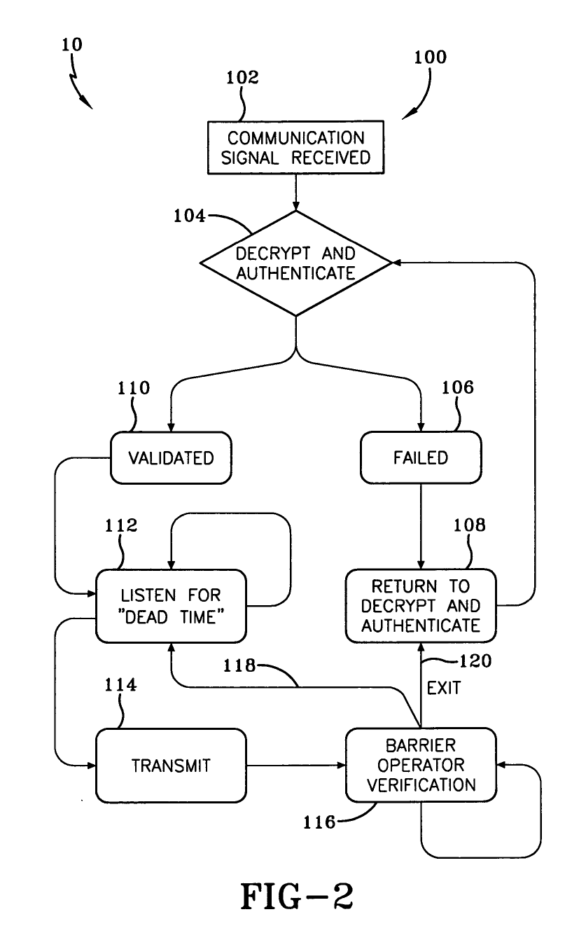

The procedural steps taken by the signal repeater system 10 to receive, authenticate, and retransmit communication signals received from a remote transmitter 60, are generally designated by numeral 100, as shown in FIG. 2. Initially, at step 102, the repeater unit 11 receives a transmitted communication signal sent from the remote transmitter 60. The repeater unit 11 then stores the data contained in the communication signal into the memory of the controller 12. The data contained in the communication signal may contain various data segments, including a preamble segment to provide synchronizing between various transmitters and receivers, a function segment identifying the particular function to be invoked by the barrier operator 50, and a security code segment embodying the unique security code of a particular remote transmitter 60. The security code segment may be comprised of a rolling/hopping code provided in devices made by Microchip Technology, Inc. under the trademark by KEELOQ®. It should also be appreciated the communication signal may be encrypted using any desired encryption method. Next, the received communication signal is decrypted and authenticated by the repeater unit 11, as indicated by step 104.

Specifically, during the authentication process at step 104 the controller 12 of the repeater unit 11 determines whether the security code contained in the communication signal has been previously stored in the memory of controller 12. If the security code of the particular remote transmitter 60 is not found in the memory of the controller 12, then the security code has failed the authentication process and the communication signal is not retransmitted by the repeater transmitter 16, as indicated at step 106. Next, at step 108, the process 100 returns to step 104 where the repeater unit 11 continues to decrypt and authenticate any communication signals received by the repeater unit 11.

However, if the security code of the particular remote transmitter 60 is found by the controller 12 of the repeater unit 11, then the communication signal is validated, as indicated at step 110. Once validated, the process 100 continues to step 112, where the repeater unit 11 listens for a dead-time period in which no signals are being transmitted/received from other transmitter/receiver pairs that may be part of the barrier operator 50. A standard transmitter (portable, wall-station or keypad) transmits an approximate 100 ms word that consists of about 50 ms of data pulse and 50 ms of blank time (blank time is no transmission, simply a delay). To avoid transmission collisions with other transmitters, the repeater insures that no transmissions are active from another transmitter for 100 ms. If no signals are detected for 100 ms, then the repeater may transmit. The same message is sent for at least one second, plus any additional time the command button is held. Once the repeater controller 12 has verified the first captured transmission, it will wait and decode the next 66-bit of information while doing a byte-for-byte comparison of this message against the verified transmission. If all the bytes with the current message equal the bytes of the decrypted captured message, then the same message is transmitted during the dead-time of the originating transmitter. The process 100 continues at step 112 until a dead-time period is detected by the repeater receiver 14. Once a dead-time period is detected, for example 100 ms or some other time period, the repeater transmitter 16 retransmits the stored communication signal to the barrier operator 50 via the transmitter antenna 20, as indicated at step 114. Next, the process 100 continues to step 116, where the repeater unit 11 awaits a verification signal sent from the barrier operator 50 indicating that the barrier operator 50 has successfully received the retransmitted communication signal sent by the repeater unit 11. In one embodiment, the verification signal may comprise a light fixture command signal corresponding to a light on function provided by the barrier operator 50. That is, when the barrier operator 50 has successfully received a retransmitted communication signal from the repeater unit 11, the transceiver 52 of the barrier operator 50 transmits a verification signal, such as a light fixture command signal, to the repeater receiver 14 of the repeater unit 11. Furthermore, the repeater unit continues to await the verification signal at step 116 for one (1) second, although any other predetermined amount of time may be used. If the repeater unit 11 does not receive the verification signal from the barrier operator 50 within the predetermined time period, as indicated at 118, the process 100 returns to step 112 where the repeater unit 11 resumes listening for a dead-time period as previously discussed to attempt another retransmission of the communication signal. However, if the repeater unit 11 does receive the verification signal from the barrier operator 50 within the predetermined time period, as indicated at 120, then the process 100 returns to step 104 by way of step 108, whereby the repeater unit 11 continues to decrypt and authenticate any further communication signals received by the repeater unit 11.

In one embodiment of the signal repeater system 10, the repeater receiver 14 may include a pre-filter, allowing the repeater unit 11 to filter any interference that may impair the ability of the repeater receiver 14 to properly detect a transmitted communication signal. It should also be appreciated that the repeater unit 11 may comprise a form factor that allows the repeater unit 11 to be mounted outside the range of electrical noise created by the motor of the barrier operator 50 and thereby provide enhanced wireless transmitter 60 reception. Additionally, the repeater unit 11 is configured for use with exiting barrier operators 50, without requiring any modification to the barrier operator 50.

In another embodiment of the signal repeater system 10, the network interface 22 allows the repeater unit 11 to be coupled to any computer network, such as the Internet. This connectivity allows a remote host, such as a networked computer which is part of a home network, to connect to the repeater unit 11 to access various data content and to remotely invoke certain functions provided by the repeater unit 11 and the barrier operator 50. Specifically, such data content and functions may be formatted using any known protocol, including HTML, using any network protocol such as TCP/IP to distribute such data content. Additionally, the data content provided may comprise: whether there has been a mains power outage, the number of hours of continuous running time of the repeater unit 11 and/or barrier operator 50, number of operating cycles of the barrier operator 50, or any other desired information. Additionally, such functions provided by the repeater unit 11 may include, open/close of the access barrier 58, delay open/close of the access barrier 58, or any other desired function that may be provided by the barrier operator 50.

It will, therefore, be appreciated that one advantage of one or more embodiments of the signal repeater system in accordance with the concepts of the present invention is that the repeater unit provides a learn mode allowing the repeater unit to store the identification code of specific remote transmitters. Still another advantage of the signal repeater system is that the repeater unit only retransmits communication signals sent from remote transmitters that have been validly authenticated by the repeater unit. Yet another advantage of the signal repeater system is that a network interface is provided allowing the repeater unit to be connected to a computer network. An additional advantage of the signal repeater system is that a remote host, such as a computer, can access the repeater unit via a computer network to access various data and functions provided by the repeater unit.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto and thereby. Accordingly, for an appreciation of the true scope and breadth of the invention, reference should be made to the following claims.

What is claimed is:

1. A repeater unit to retransmit communication signals received from a remote transmitter comprising:
a repeater receiver having a receiver antenna to receive the communication signal;
a controller adapted to store and authenticate the received communication signal;
a repeater transmitter having a transmitter antenna, said repeater transmitter coupled to said controller, wherein said repeater transmitter retransmits said stored communication signal if said communication signal is authenticated by said controller.

2. The repeater unit according to claim 1, wherein said repeater transmitter retransmits said stored communication signal during a dead-time period.

3. The repeater unit according to claim 1, wherein said stored communication signal is retransmitted until said repeater receiver receives a validation signal from a device receiving said retransmitted communication signal.

4. The repeater unit according to claim 3, wherein said validation signal comprises a light fixture command signal.

5. The repeater unit according to claim 1, further comprising:
an indicator connected to said controller.

6. The repeater unit according to claim 5, wherein said indicator identifies an operational status of said repeater unit.

7. The repeater unit according to claim 1, further comprising a selector connected to said controller.

8. The repeater unit according to claim 7, wherein said selector enables a learn mode provided by said repeater unit.

9. The repeater unit according to claim 1, further comprising a network interface connected to said controller to enable connection of the repeater unit to a computer network.

10. The repeater unit according to claim 9, wherein said network interface comprises an Ethernet adapter.

11. The repeater unit according to claim 9, wherein said network interface comprises a wireless interface.

12. A method of retransmitting a received communication signal from a remote transmitter comprising:
providing a barrier operator having a communication signal reception range;
providing a repeater unit having a communication signal transmission range;
positioning said repeater unit relative to said barrier operator, such that said communication signal transmission range of said repeater unit overlaps said communication signal reception range of said barrier operator;
transmitting a communication signal from a remote transmitter to actuate said barrier operator;
receiving said transmitted communication signal at said repeater unit;
storing said transmitted communication signal at said repeater unit;
authenticating said communication signal at said repeater unit to determine if said communication signal originates from said learned remote transmitter; and
retransmitting said communication signal to said barrier operator by said repeater unit if said repeater unit validates said communication signal at said authenticating step.

13. The method according to claim 12, further comprising:
receiving said communication signal;
storing and authenticating said communication signal received by said repeater receiver in a controller; and
retransmitting said authenticated communicational signal by a repeater transmitter coupled to said controller.

14. The method according to claim 13, further comprising:
providing an indicator coupled to said controller, so as to identify the status of said repeater unit.

15. The method according to claim 13, further comprising:
providing a selector coupled to said controller; and
enabling a learn mode of said repeater unit by actuating said selector.

16. The method according to claim 13, further comprising connecting a network device to a network interface provided by said controller.

17. The method according to claim 16, wherein said network interface comprises an Ethernet adapter.

18. The method according to claim 16, wherein said network interface comprises a wireless interface.

19. The method according to claim 12, further comprising:
including a security code unique to said remote transmitter in said communication signal.

20. The method according to claim 12, further comprising:
performing the retransmitting step during a dead-time period.

21. The method according to claim 12, further comprising:
repeating said retransmitting step until said repeater unit receives a verification signal transmitted from said barrier operator.
